(19) United States
(12) Patent Application Publication
(10) Pub. No.: US 2014/0050048 A1
(43) Pub. Date: Feb. 20, 2014

(54) Harmonic Ultrasound Imaging Using Synthetic Aperture Sequential Beamforming

(71) Applicants: Jorgen Arendt Jensen, Horsholm (DK); Yigang Du, Naerum (DK); Henrik Jensen, Bagsvaerd (DK)

(72) Inventors: Jorgen Arendt Jensen, Horsholm (DK); Yigang Du, Naerum (DK); Henrik Jensen, Bagsvaerd (DK)

(73) Assignee: B-K MEDICAL APS, Herlev (DK)

(21) Appl. No.: 14/114,619

(22) PCT Filed: Apr. 29, 2011
(86) PCT No.: PCT/IB2011/000924

§ 371 Date: Oct. 29, 2013

(51) Int. Cl. G03B 42/06

(52) U.S. Cl. CPC G03B 42/06
USPC 367/11; 367/7

(57) ABSTRACT

A method includes generating an ultrasound image based on the harmonic components in the received echoes using multi-stage beamforming and data generated therefrom. An ultrasound imaging system (100, 200) includes a transducer array (108) including a plurality of transducer elements configured to emit ultrasound signals and receive echoes generated in response to the emitted ultrasound signals. The ultrasound imaging system further includes transmit circuitry (110) that generates a set of pulses that actuate a set of the plurality of transducer elements to emit ultrasound signals. The ultrasound imaging system further includes receive circuitry (112), including a first beamformer (122) configured to process the received echoes, generating intermediate scan lines. Memory (126) stores the generated intermediate scan lines. The ultrasound imaging system further includes a synthetic aperture processor (128), including a second beamformer (130) configured to process the stored intermediate scan lines, based on a synthetic aperture algorithm, generating a focused image.

### TECHNICAL FIELD

The following generally relates to ultrasound imaging and more particularly to harmonic ultrasound imaging using synthetic aperture sequential beamforming, with and without pulse inversion.

### BACKGROUND

Ultrasound imaging systems provide useful information about the interior characteristics of an object or subject under examination. Conventional B-mode ultrasound imaging is performed by actuating a set of transducer elements to form an ultrasound beam having a fixed transmit focal point and sweeping the ultrasound beam through an examination area while transmitting pulses and detecting echoes. The echoes are delayed and summed by a beamformer to form B-mode scan lines, which are focused at a single transmit focal spot, which limits image resolution.

With synthetic aperture imaging, a single transducer element is used to emit a spherical wave. The backscattered signals are registered using a multi-element receive aperture and samples from all channels are stored. Delay-and-sum beamforming is applied to the data to construct a low-resolution image from a single emission. Several emissions from single elements across the aperture synthesize a larger aperture and the low-resolution image's can be added into a single high-resolution image that is dynamically focused in both transmit and receive. Unfortunately, this approach is computationally intensive and requires a large amount of memory for storing the data.

Synthetic aperture sequential beamforming is a two-stage beamforming procedure, which can improve lateral resolution, independent of image depth, relative to conventional B-mode imaging using a dynamic receive focus. Generally, the first stage of the procedure includes beamforming received echoes and generating a set of conventional B-mode scan lines with the same fixed transmit and receive focal spot. The second stage of this procedure includes beamforming the set of scan lines and generating an image using a synthetic aperture imaging algorithm. With this approach, a dynamic focus in both transmit and receive can be achieved.

Harmonic imaging is B-mode imaging based on the harmonics of the echo signals. Pulse inversion or a bandpass filter can be used to extract the desired harmonic component. With pulse inversion, a pulse and a delayed inverted copy of the pulse are transmitted to the same focal spot, and the corresponding received echo signals are added, which cancels out the fundamental components (which are inverted copies of each other) and keeps the even harmonic components. The second harmonic component will have a frequency that is two times the frequency of the fundamental component, and this higher frequency provides for generating images with enhanced contrast characteristics.

Pulse inversion has been proposed to be used with conventional synthetic aperture imaging. However, where a single transducer element is used to emit a spherical wave, the transmitting energy for the signal is too low so that the true signals become much lower when using pulse inversion. A multi-element emission can be used to enhance the transmitting energy; however, this requires a relatively large amount of memory for storing the data.

In view of the above, there is an unresolved need for other approaches for processing ultrasounds data.

### SUMMARY

Aspects of the application address the above matters, and others.

In one aspect, a method includes generating an ultrasound image based on the harmonic components in the received echoes using multi-stage beamforming and data generated therefrom.

In another aspect, an ultrasound imaging system includes a transducer array including a plurality of transducer elements configured to emit ultrasound signals and receive echoes generated in response to the emitted ultrasound signals. The ultrasound imaging system further includes transmit circuitry that generates a set of pulses that actuate a set of the plurality of transducer elements to emit ultrasound signals. The ultrasound imaging system further includes receive circuitry, including a first beamformer configured to process the received echoes, generating intermediate scan lines. Memory stores the generated intermediate scan lines. The ultrasound imaging system further includes a synthetic aperture processor, including a second beamformer configured to process the stored intermediate scan lines, based on a synthetic aperture algorithm, generating a focused image.

In another aspect, a method includes receiving harmonic ultrasound imaging echoes, beamforming the harmonic ultrasound imaging echoes, generating intermediate scan lines, and beamforming the intermediate scan lines, generating a focused image.

Those skilled in the art will recognize still other aspects of the present application upon reading and understanding the attached description.

### BRIEF DESCRIPTION OF THE DRAWINGS

The application is illustrated by way of example and not limitation in the figures of the accompanying drawings, in which like references indicate similar elements and in which:

FIG. 1 illustrates an example ultrasound imaging system that includes componentry for harmonic imaging with pulse inversion and multi-stage synthetic aperture beamforming;

FIG. 2 illustrates an example ultrasound imaging system that includes componentry for harmonic imaging with bandpass filtering and multi-stage synthetic aperture beamforming;

FIG. 3 illustrates an example method using synthetic aperture sequential beamforming and harmonic imaging with pulse inversion; and

FIG. 4 illustrates an example method using synthetic aperture sequential beamforming and harmonic imaging without pulse inversion.

### DETAILED DESCRIPTION

The following describes an ultrasound imaging approach that generates a focused image using harmonic imaging and multi-stage synthetic aperture beamforming. For the first stage, a beamformer generates a set of intermediate scan lines based on a harmonic component of received echo signals. In one instance, the harmonic component is a second harmonic, which can be extracted from the received signal using pulse inversion, a bandpass filter, or other approach, which removes the fundamental component of the signal. Both the transmit and the receive signals have fixed single focal points.

For the second stage, a beamformer generates a dynamically focused image, in both transmit and receive, based on the intermediate scan lines. This approach allows for generating an image with better contrast and focusing in the axial and lateral directions, relative to a configuration in which the combination of harmonic imaging and multi stage synthetic aperture beamforming are not used, and can be implemented cost effectively for both higher and lower end ultrasound imaging systems. Moreover, the memory required to store the intermediate scan lines is less then that for storing data for individual transducer elements.

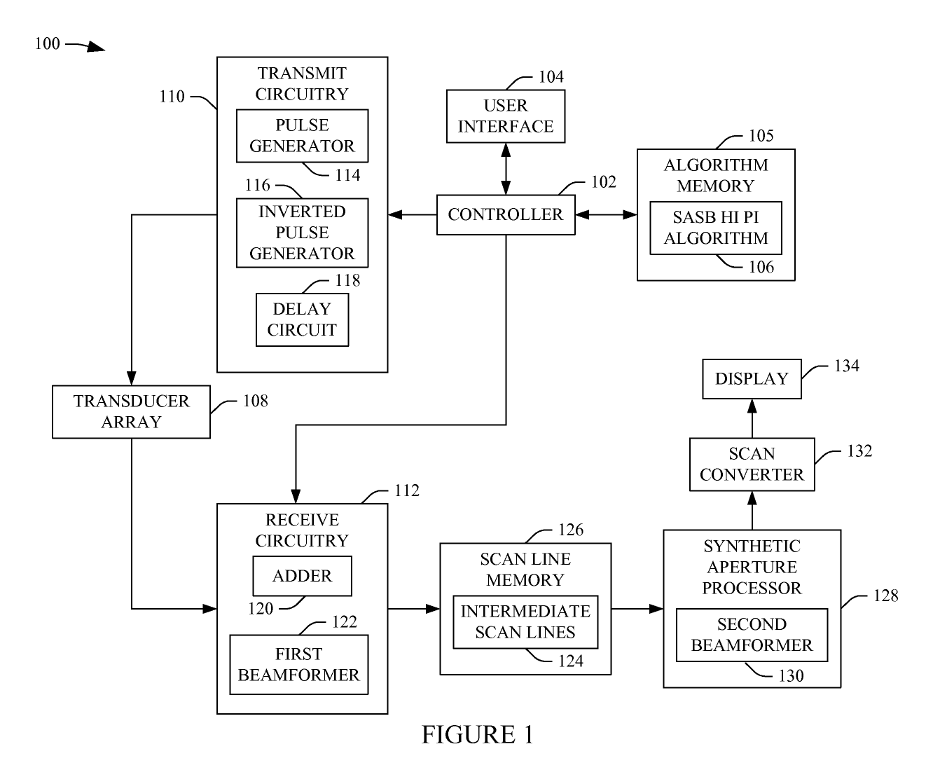

Initially referring to FIG. 1, an example ultrasound imaging system 100 is illustrated. The ultrasound imaging system 100 includes a controller 102, which controls one or more of the components of the system 100.

The ultrasound imaging system 100 further includes a user interface 104, which is in electrical communication with the controller 102, with one or more input devices (e.g., a button, a knob, a slider, a touch pad, etc.) and one or more output devices (e.g., a display screen, lights, a speaker, etc.). In one instance, where the system 100 is configured for a plurality of different scanning modes, the user interface 104 allows a user of the system 100, via an input device, to generate and send a signal indicative of a desired scanning mode to the controller 102. The ultrasound imaging system 100 further includes algorithm memory 105 with, at least, a harmonic imaging with pulse inversion and multi-stage synthetic aperture beamforming algorithm, referred to herein as synthetic aperture sequential beamforming (SASB) harmonic imaging (HI) with pulse inversion (PI), or SASB HI PI algorithm 106.

The ultrasound imaging system 100 also includes a transducer array 108, transmit circuitry 110 and receive circuitry 112. The transducer array 108 includes an array of transducer elements (e.g., 64, 128, 192, etc.) used to alternately transmit ultrasound signals and receive echo signals. In this embodiment, the array includes a linear array of transducer elements. In other embodiments, the array may alternatively include a curved array and/or a two dimensional array of transducer elements.

The transmit circuitry 110 includes a pulse generator 114, which generates a set of pulses that are conveyed to the transducer array 108. The set of pulses actuates a corresponding set of the transducer elements of the transducer array 108, causing the elements to emit ultrasound signals into an examination field. The transmit circuitry 110 also includes an inverted pulse generator 116, which generates a set of pulses, which includes an inverted copy of the set of pulses generated by the pulse generator 114. The inverted pulses are also conveyed to the transducer array 108 and likewise elicit emission of ultrasound signals from the corresponding set of the transducer elements.

The transmit circuitry 110 further includes a delay circuit 118 delays conveyance of the inverted pulses to the transducer array 108 by a predetermined time delay. In an alternative embodiment, the inverted pulse generator 116 is omitted, and the pulse generator 114 emits the same set of pulses twice, with the second set being emitted after the time delay, and a pulse inverter(s) or the like inverts the second set of pulses to produce the inverted copy that is conveyed to the transducer array 108. In the illustrated embodiment, a plurality of the pulses and the delayed inverted pulses are generated and emitted for forming a plurality of B-mode scan lines (e.g., 100, 200, etc.).

The receive circuitry 112 receives echoes in response to the emitted ultrasound signals. The echoes, generally, are a result of the interaction between the emitted ultrasound signals and the structure in the scan field of view. The individual echoes include a fundamental component, corresponding to the frequency of the emitted signals, and harmonic components (e.g., second, third, fourth, etc.). The fundamental components for a pulse and an inverted pulse, as well as for the odd harmonics, will be inverted copies of each other. The even harmonics will not be inverted copies of each other.

The receive circuitry 112 includes an adder 120. The adder 120 adds the echoes for corresponding pulse/inverted pulse pairs. As the fundamental components and odd harmonics for a corresponding pulse/inverted pulse pair are inverted copies of each other, the fundamental components and the odd harmonics cancel each other out (or add to zero). In contrast, the even harmonic components double. The second harmonic component will have a frequency (2 f) that is about twice the frequency (f) of the fundamental component.

The receive circuitry 112 also includes a first beamformer 122. The first beamformer 122 applies time delays to the individual second harmonic signals and sums, as a function of time, the time delayed individual second harmonic signals into a single signal. This is done for each of the pulse/inverted pulse pairs, producing a set of intermediate scan lines 124 in which multiple intermediate scan lines of the set 124 include a same lower resolution image point from a given spatial position.

The receive circuitry 112 further includes scan line memory 126 that stores the intermediate scan lines 124. In one instance, the scan line memory 126 includes first in first out (FIFO) memory, which successively stores intermediate scan lines as they are created, wherein each scan line corresponds to a different pulse/inverted pulse pair.

The ultrasound imaging system 100 further includes a synthetic aperture processor 128 with a second beamformer 130, which beamforms the intermediate scan lines 124 stored in the scan line memory 126, producing a focused image having a continuous transmit and receive focus. In one instance, this includes creating a set of higher resolution image points by combining information from multiple intermediate scan lines, of the set 124, that represent information from the spatial position of the image.

The ultrasound imaging system 100 further includes a scan converter 132 that scan converts the output of the second beamformer 130 to generate data for display, for example, by converting the data to the coordinate system of the display. The scan converter 132 can be configured to employ analog and/or digital scan converting techniques.

The ultrasound imaging system 100 further includes a display 134 that can be used to visually present the scan converted data. Such presentation can be in an interactive graphical user interface (GUI), which allows the user to selectively rotate, scale, and/or manipulate the displayed data. Such interaction can be through a mouse or the like and/or a keyboard or the like.

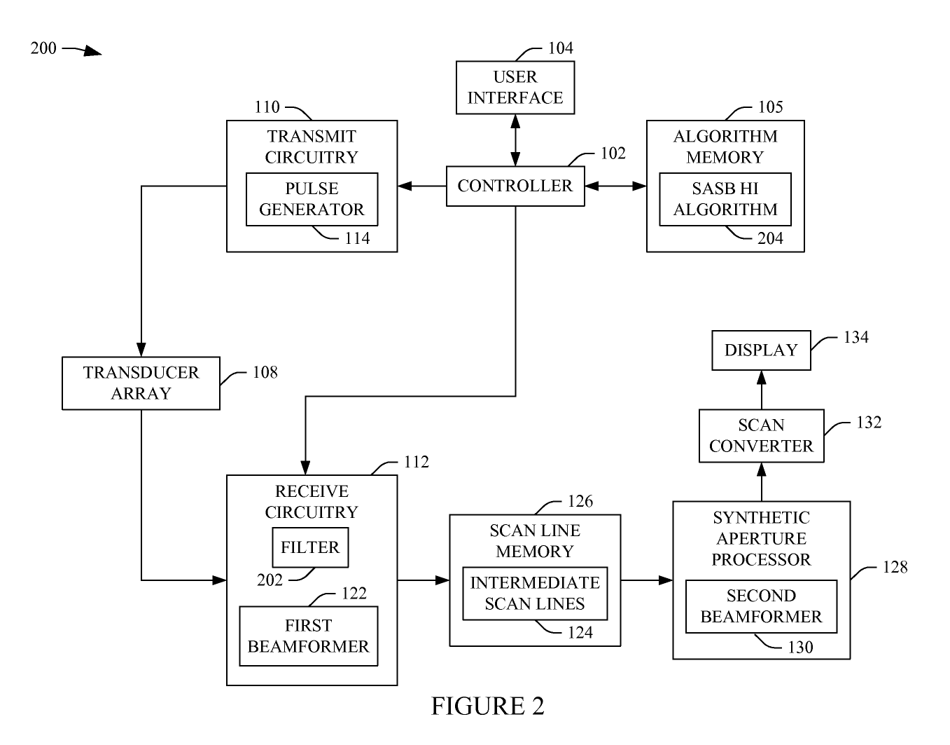

FIG. 2 illustrates a variation of the ultrasound imaging system of FIG. 1. In FIG. 2, an ultrasound imaging system 200 is substantially similar to the ultrasound imaging system 100 of FIG. 1, except that the inverted pulse generator 116 and delay circuit 118 of the transmit circuitry 110 and the adder of the receive circuitry 112 are omitted, the receive circuitry 112 includes a filter 202, and the algorithm memory 105 includes a SASB HI algorithm 204.

In this example, the filter 202 is configured to extract a desired harmonic component (e.g., the second harmonic) from the received echo signal. For example, as noted above, the frequency (2 f) of the second harmonic component will be on the order of twice the frequency (f) of the fundamental component. As such, a bandpass filter centered at the frequency (2 f) of the second harmonic component can be used to pass the second harmonic component and filter the fundamental component.

The second harmonic component can then be processed as discussed in connection with FIG. 1 or otherwise.

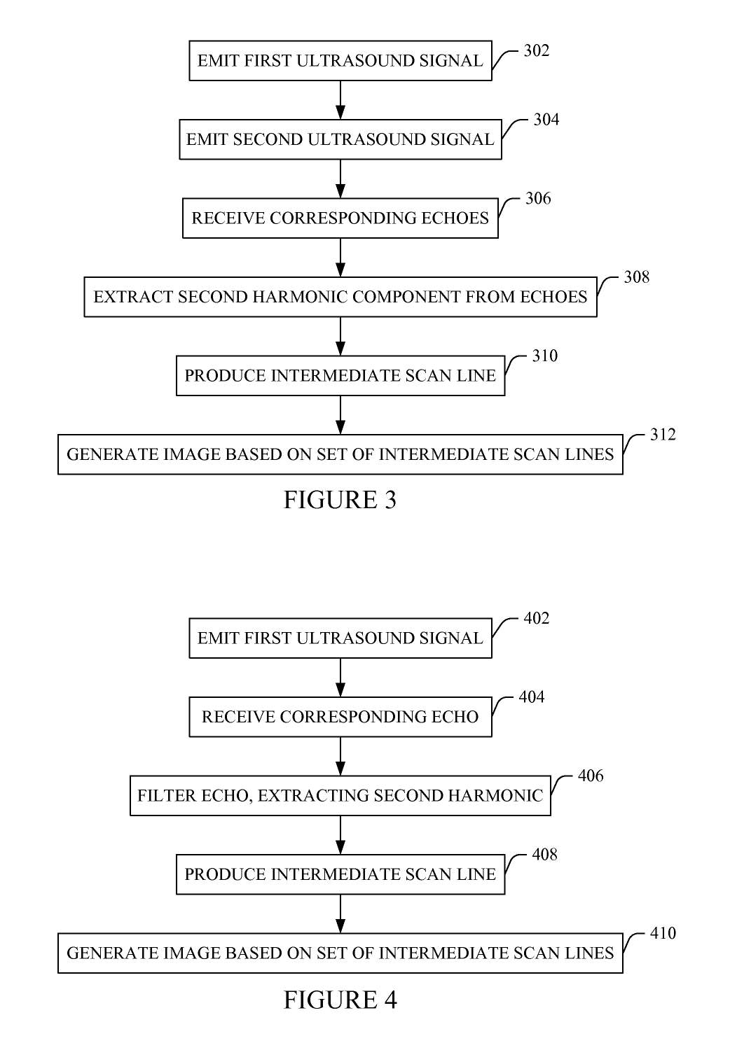

FIG. 3 illustrates an example method for employing the ultrasound imaging system.

At 302, a first set of pulses are generated and conveyed to a transducer array, actuating a corresponding set of transducer elements to emit first ultrasound signals.

At 304, after a predetermined time delay, a second set of pulses, which includes an inverted copy of the first set of pulses, are generated and conveyed to the transducer array, actuating the corresponding set of transducer elements to emit second ultrasound signals.

At 306, echoes corresponding to the first and second ultrasound signals are received.

At 308, the echoes added, extracting the second harmonic component from the echoes.

At 310, the second harmonic components are delayed and summed, producing an intermediate scan line, which is stored in memory.

Acts 302 to 310 are repeated a plurality of time for a plurality of different scan lines, resulting in a set of intermediate scan line stored in memory.

At 312, a focused image is generated based on the set of intermediate scan lines using a synthetic aperture beamforming.

Optionally, the focused image in converted for display on a monitor and displayed on a monitor.

FIG. 4 illustrates an example method for employing the ultrasound imaging system.

At 402, a set of pulses are conveyed to a transducer array, actuating a corresponding set of transducer elements to emit ultrasound signals.

At 404, the echo corresponding to the ultrasound signals is received.

At 406, the echo is filtered, extracting the second harmonic.

At 408, the second harmonic is beamformed, generating an intermediate scan line.

Acts 402 to 408 are repeated a plurality of time for a plurality of different scan lines, resulting in a set of intermediate scan line stored in memory.

At 410, a focused image is generated based on the set of intermediate scan lines using a synthetic aperture beamforming.

Optionally, the focused image is converted for display on a monitor and displayed on a monitor.

In the above methods, the acts are provided for explanatory purposes and are not limiting. As such, one or more of the acts may be omitted, one or more acts may be added, one or more acts may occur in a different order (including simultaneously with another act), etc.

Furthermore, the above may be implemented via one or more processors executing one or more computer readable instructions encoded or embodied on computer readable storage medium such as physical memory which causes the one or more processors to carry out the various acts and/or other functions and/or acts. Additionally or alternatively, the one or more processors can execute instructions carried by transitory medium such as a signal or carrier wave.

It is to be appreciated that in one instance, the full width half maximum (FWHM) of an image point along the lateral direction for the approach described herein utilizing synthetic aperture sequential beamforming (SASB) harmonic imaging (HI) with pulse inversion (PI) (SASB HI PI) is, on average, 66% less than the FWHM for conventional ultrasound imaging.

For comparative purposes, the FWHM for conventional ultrasound with dynamic receive focus (DRF) imaging with pulse inversion is, on average, only 46% less than the FWHM for conventional ultrasound imaging, and the FWHM for synthetic aperture sequential beamforming (SASB) imaging is, on average, only 35% less than the FWHM for conventional ultrasound imaging.

The foregoing shows that at least in this instance, the SASB HI PI approach described herein has better lateral resolution than conventional ultrasound imaging, conventional ultrasound imaging with DRF, and SASB imaging. Moreover, the FWHM for the SASB HI PI approach is more stable relative to conventional ultrasound imaging and SASB imaging.

In addition, the envelope for the center image lines, which go through the point target, is shorter for SASB HI PI relative to conventional ultrasound imaging with DRF, conventional ultrasound imaging with PI, and SASB imaging, which means the SASB HI PI approach has better axial resolution, at least in this instance.

The application has been described with reference to various embodiments. Modifications and alterations will occur to others upon reading the application. It is intended that the invention be construed as including all such modifications and alterations, including insofar as they come within the scope of the appended claims and the equivalents thereof.

1. A method, comprising:
generating an ultrasound image based on the harmonic components in the received echoes using multi-stage beamforming and data generated therefrom.

2. The method of claim 1, wherein the ultrasound image is focused in both axial and lateral directions of the image.

3. The method of claim 1, wherein the ultrasound image is generated based on second harmonic components of the received echoes.

4. The method of claim 3, further comprising:
extracting the second harmonic components from the received echoes;
beamforming, during a first stage of the multi-stage beamforming, a set of intermediate scan lines based on the second harmonic components, wherein the intermediate scan lines have a single transmit focal point; and
beamforming, during a second stage of the multi-stage beamforming, the set of intermediate scan lines, producing a higher resolution ultrasound image.

5. The method of claim 4, further comprising:
actuating a set of transducer elements with a first set of pulses, causing the first set of transducer elements to emit a first ultrasound signal;
actuating, after lapse of a predetermined time delay, the set of transducer elements with a second set of pulses, causing the set of transducer elements to emit a second ultrasound signal, wherein the second ultrasound signal is an inverted copy of the first ultrasound signal;
receiving a first echo signal corresponding to the first ultrasound signal and subsequently receiving a second echo signal corresponding to the first ultrasound signal, wherein each echo signal includes a fundamental component and a harmonic component; and
adding the first and second echo signals, which cancels the fundamental components, which are inverted copies of each other, and which combines and extracts the second harmonic components, providing a second harmonic component for the pair of pulses.

6. The method of claim 4, wherein the second harmonic component has a frequency that is on an order of twice a frequency of the fundamental component.

7. The method of claim 4, further comprising:
actuating a set of transducer elements with a set of pulses, causing the set of transducer elements to emit an ultrasound signal;
receiving an echo signal corresponding to the ultrasound signal, the echo signal including a fundamental component and a harmonic component; and
bandpass filtering the echo signal to extract the harmonic component.

8. The method of claim 7, wherein the second harmonic component has a frequency that is on an order of twice a frequency of the fundamental component, and the bandpass filter is centered at two times the frequency of the fundamental component.

9. The method of claim 4, the beamforming, during the second stage of the multi-stage beamforming, comprising:
employing synthetic aperture beamforming of the set of intermediate scan lines to produce the higher resolution ultrasound image.

10. The method of claim 9, the synthetic aperture beamforming, comprising:
combining information from multiple intermediate scan lines that represent information from a spatial position of the image.

11. An ultrasound imaging system, comprising:
a transducer array including a plurality of transducer elements configured to emit ultrasound signals and receive echoes generated in response to the emitted ultrasound signals;
transmit circuitry that generates a set of pulses that actuate a set of the plurality of transducer elements to emit ultrasound signals;
receive circuitry, including a first beamformer configured to process the received echoes, generating intermediate scan lines;
memory that stores the generated intermediate scan lines; and
a synthetic aperture processor, including a second beamformer configured to process the stored intermediate scan lines, based on a synthetic aperture algorithm, and generate a focused image.

12. The ultrasound imaging system of claim 11, the transmit circuitry, comprising:
a pulse generator that generates a first sub-set of the set of pulses; and
an inverted pulse generator that generates a second sub-set of the set of pulses, which is an inverted copy of the first sub-set, wherein the transmit circuitry conveys the first sub-set of the set of pulses to the transducer array and subsequently, after a predetermined time delay, conveys the second sub-set of the set of pulse to the transducer array.

13. The ultrasound imaging system of claim 12, the receive circuitry, comprising:
an adder that sums first received echoes that correspond to the first sub-set of the set of pulses and second received echoes that correspond to the second sub-set of the set of pulses, generating a harmonic component signal; and
a first beamformer that processes the harmonic signal and generates a scan line indicative thereof.

14. The ultrasound imaging system of claim 11, the receive circuitry, comprising:
a filter configured to pass a predetermined harmonic component of the received echoes and filter at least a fundamental component of the received echoes, generating a harmonic component signal; and
a first beamformer that processes the harmonic signal and generates a scan line indicative thereof.

15. The ultrasound imaging system of claim 11, wherein the harmonic component is a second harmonic component.

16. The method of claim 13, wherein the second harmonic component has a frequency that is twice a frequency of the fundamental component.

17. The ultrasound imaging system of claim 11, further comprising:
a processor configured to beamform a set of the generated scan lines generated by the first beamformer and generate the focused image based thereon.

18. The ultrasound imaging system of claim 17, wherein the processor utilizes a synthetic aperture beamforming algorithm to generate the focused image.

19. A method, comprising:
receiving harmonic ultrasound imaging echoes; and
beamforming the harmonic ultrasound imaging echoes, generating intermediate scan lines; and
beamforming the intermediate scan lines, generating a focused image.

20. The method of claim 19, further comprising:
extracting a second harmonic component from the harmonic ultrasound imaging echoes; and
beamforming the second harmonic component, generating the intermediate scan lines.

21. The method of claim 19, further comprising:
beamforming the intermediate scan lines using a synthetic aperture beamforming algorithm, generating the focused image.
